(19) United States
(12) Patent Application Publication
(10) Pub. No.: US 2001/0015692 A1
(43) Pub. Date: Aug. 23, 2001

(54) Lock with an authenticated open and set function, and IC card for the same

(75) Inventors: Sunao Takanori, Tokyo (JP); Hisanori Kiyomatsu, Tokyo (JP)

Correspondence Address: DARBY & DARBY, 805 THIRD AVENUE, 27TH FLR., NEW YORK, NY, 10022, US

(73) Assignee: YOZAN INC.

(21) Appl. No.: 09/788,156

(22) Filed: Feb. 16, 2001

(30) Foreign Application Priority Data
Feb. 23, 2000 (JP) 2000-46236

(51) Int. Cl. H04B 1/00; G06F 7/00

(52) U.S. Cl. 340/5.23; 340/5.62; 382/115

(57) ABSTRACT

The present invention provides a lock with an authenticated open and set function, by which the lock may be opened without any bothersome operation for inserting a key to open the lock. An IC card 3 sends user identification information stored in a memory 34 to an authenticated open and set function unit 1. The authenticated open and set function unit 1 sends the user identification information to a collator 15 under the control of a controller 11 on reception of it. The collator 15 collates the user identification information sent from the IC card 3 with that stored in a memory 16. When both of the user identification information are coincided with each other, the collator 15 sends the collation signal, which is indicative of the user being authenticated, to the controller 11. The controller 11 gives a controller 17 a command to open a lock installed in a door 2. The controller 17 opens the lock based on the command by the controller 11.

### BACKGROUND OF THE INVENTION

1. Field of the Invention

The present invention relates to a lock installed in a door of a house, an office, or a car, or a bicycle and so on, and, especially, to a lock with an authenticated open and set function, and an IC card for the lock.

2. Description of the Prior Art

Conventionally, a lock has been used to be installed in a door of a house, an office, or a car, or a bicycle and so on. Usually, a keyhole is provided in a lock installed in a door and a bicycle, and a lock is opened by inserting a key which is a counterpart of the keyhole of the lock into the keyhole.

However, in the conventional lock, a bothersome operation for inserting the key into the keyhole has been required to open the lock. Thus, the advent of a lock with a simple function enables the lock to open without any bothersome operation, inserting the key into the keyhole, has been greatly anticipated.

### SUMMARY OF THE INVENTION

The present invention has been made in view of the above problem, and therefore has an object to offer a lock with an authenticated open and set function enables the lock to open without any bothersome operation, inserting a key into a keyhole, and an IC card for the same.

The lock according to the present invention comprises a storage means for storing a first user identification information; a collating means for collating a received second user identification information with the first user identification information stored in the storage means; and an open and set control means for opening the lock when the first and second user identification information are coincided with each other.

Incorporation of log data into the first and second user identification information, respectively, ensures a highly reliable user authentication.

Provision of a detection means for detecting access of a transmission source of the second user identification information allows activation of the authenticated open and set function only when user comes close to the detection means.

The IC card mounted in a portable terminal comprises a storage means for storing the first user identification information; and a transmission means for transmitting the first user identification information to the lock. This allows the lock to open only by accessing the IC card to the lock.

The above storage means stores a first password, and it comprises a password collating means for collating the first password with a second password input from the above portable terminal; and a mode-switching control means for switching its mode to a mode to transmit the first user identification information only when the first and second passwords are coincided with each other. This permits switching of its mode to a mode where the user identification information is transmitted only at the opening of the lock.

The mode-switching control means may switch to a mode where the first user identification information is transmitted for a predetermined time. This enables activation of the function only at the opening of the lock.

The details of the embodiments are set forth in the accompanying drawings and the description below. Other features, objects, and advantages of the present invention will be apparent from the descriptions and drawings, and from the claims.

This specification includes part or all of the contents as disclosed in the specification and/or drawings of Japanese Patent Application No.46236/2000, which is a priority document of the present application.

### BRIEF DESCRIPTION OF DRAWINGS

FIG. 1 is a block diagram showing a configuration of a lock with an authenticated open and set function according to the first embodiment of the present invention.

FIG. 2 is a user table for a lock.

FIG. 3 is a block diagram showing a configuration of a lock according to the second embodiment of the present invention.

### DETAILED DESCRIPTION OF PREFERRED EMBODIMENTS

Preferred embodiments of the present invention will be described in detail hereinafter, referring to attached drawings.

First Embodiment

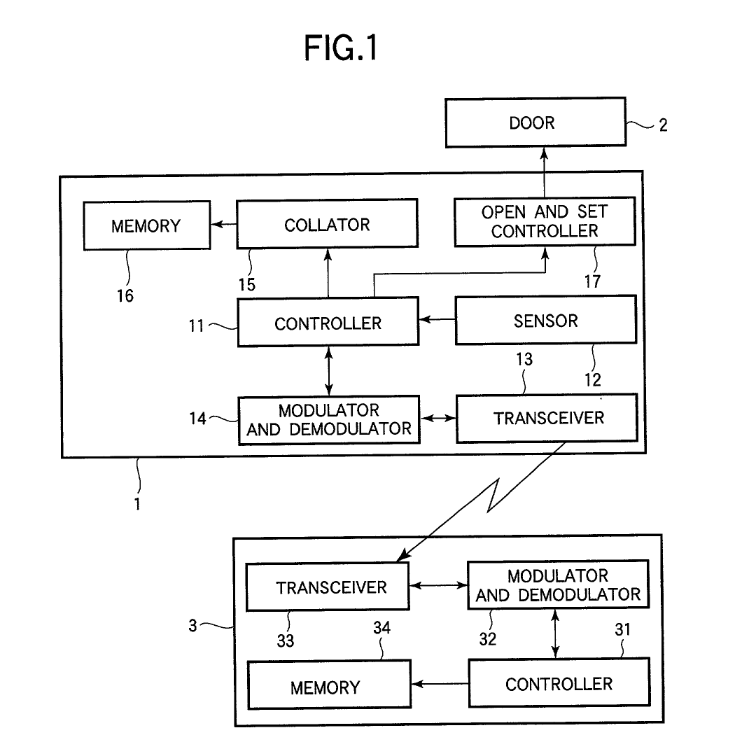

The first embodiment, where a lock with an authenticated open and set function is installed in a door of a house, will be described below. FIG. 1 is a block diagram showing a configuration of a lock according to the first embodiment of the present invention.

In FIG. 1, a door 2 is provided with an authenticated open and set function unit 1 for opening and setting after authentication. The authenticated open and set function unit 1 comprises a controller 11 for controlling the whole authenticated open and set function units.

A sensor 12 detects approach of a user holding an IC card 3 to be described below. A transceiver 13 receives a signal from the IC card 3, and transmits a signal to the IC card 3. A modulator and demodulator 14 demodulates a signal received from the IC card 3 to a signal, which is good for process in the authenticated open and set function unit 1, and modulates a signal to be transmitted to the IC card 3 to a signal, which is good for transmission to the IC card 3.

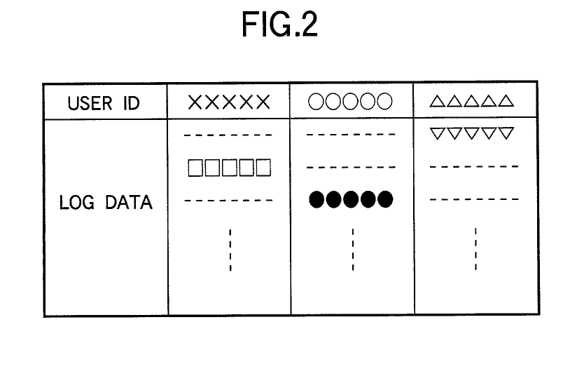

A memory 16 stores log data of users as user identification information. The log data of the users are stored in a form of a table where the log data and user IDs (identification) are corresponding with each other, for example, as shown in FIG. 2. As log data of the lock, for example, list of dates and hours for the past 10-times use of the lock are recorded. When another new use is occurred, the log data are updated. As mentioned above, using the log data as user identification information ensures a highly reliable user authentication.

A collator 15 collates the user identification information stored in the memory 16 with that transmitted from the IC card 3. An open and set controller 17 controls opening and setting of the lock after user authentication by collating the user identification information.

The IC card 3 comprises a controller 31 for controlling the whole IC card. A transceiver 33 receives a signal from the authenticated open and set function unit 1, and transmits a signal to the authenticated open and set function unit 1. A modulator and demodulator 32 demodulates a signal received from the authenticated open and set function unit 1 to a signal, which is good for process in the IC card 3, and modulates a signal to be transmitted to the authenticated open and set function unit 1 to a signal, which is good for transmission to the authenticated open and set function unit 1. A memory 34 stores user identification information in the same manner as the memory 16.

The operation of the lock having the above configuration will be described below.

Firstly, previous user registration is required at the authenticated open and set function unit 1, that is, a user ID is registered in the authenticated open and set function unit 1. The user ID is transmitted from the transceiver 33 of the IC card 3 to receive it at the transceiver 13 of the authenticated open and set function unit 1, which is in turn written in a user table of the memory 16.

Simultaneously, dummy log data are transmitted from the transceiver 13 of the authenticated open and set function unit 1 to receive it at the transceiver 33 of the IC card 3, which is then written in the user table of the memory 34.

In the memory 16 of the authenticated open and set function unit 1 and the memory 34 of the IC card 3, user IDs and dummy log data are being recorded in corresponding with each other in the user table.

The lock installed in the door 2 is in a setting state as a usual state. When a user holding an IC card 3 approaches the door 2 in which the authenticated open and set function unit 1 is installed to a predetermined distance, the sensor 12 detects his access. Any type of sensors with a capability to detect access of objects are available for the above sensor 12. The function may run only when the user holding the IC card comes close to the lock.

When the user access is detected by the sensor 12, a detected signal is sent from the sensor 12 to the controller 11. A control signal indicative of ready for user authentication is sent to the modulator and demodulator 14 by the controller 11. The modulator and demodulator 14 sends the control signal to the transceiver 13 after modulation of the control signal into a signal, which is good for transmission to the IC card 3. The transceiver 13 sends the modulated control signal to the IC card 3.

In the IC card 3, the transceiver 33 receives the control signal to demodulate it at the modulator and demodulator 32. After receiving the control signal, the controller 31 sends the user identification information, that is, user IDs and log data stored in the memory 34 to the modulator and demodulator 32. The user identification information is modulated into a signal, which is good for transmission to the authenticated open and set function unit 1 so as to send it to the transceiver 33. The transceiver 33 sends the modulated user identification information to the authenticated open and set function unit 1.

In the authenticated open and set function unit 1, the user identification information is received at the transceiver 13, and demodulated in the modulator and demodulator 14. The controller 11 sends the demodulated user identification information to the collator 15, which collates the user identification information sent from the IC card 3 with that stored in the memory 16. When both of the user identification information are coincided with each other, the collator 15 sends the collation signal, indicative of user being authenticated, to the controller 11.

On reception of the collation signal, the controller 11 gives the controller 17 a command to open the lock installed in the door 2. The controller 17 opens the lock based on the command from the controller 11. Then, the oldest record in the log data is deleted, and new date and hour of the last opening is recorded to update the contents of the log data. The controller 17 sets the lock when the door 2 is closed after it is opened once.

On the other hand, when both of the user identification information are not coincided with each other the collation signal is not sent to the controller 11. As a result, the collation signal is not sent to the controller 17, resulting in failure in opening of the lock installed in the door 2.

The lock according to the first embodiment is configured to collate the user identification information transmitted from the user side with that in the lock side, and to open the lock when both of the user identification information are coincided. Accordingly, a mere access of the IC card to the lock enables opening of the lock, without any bothersome operation for inserting a key to open the lock.

Second Embodiment

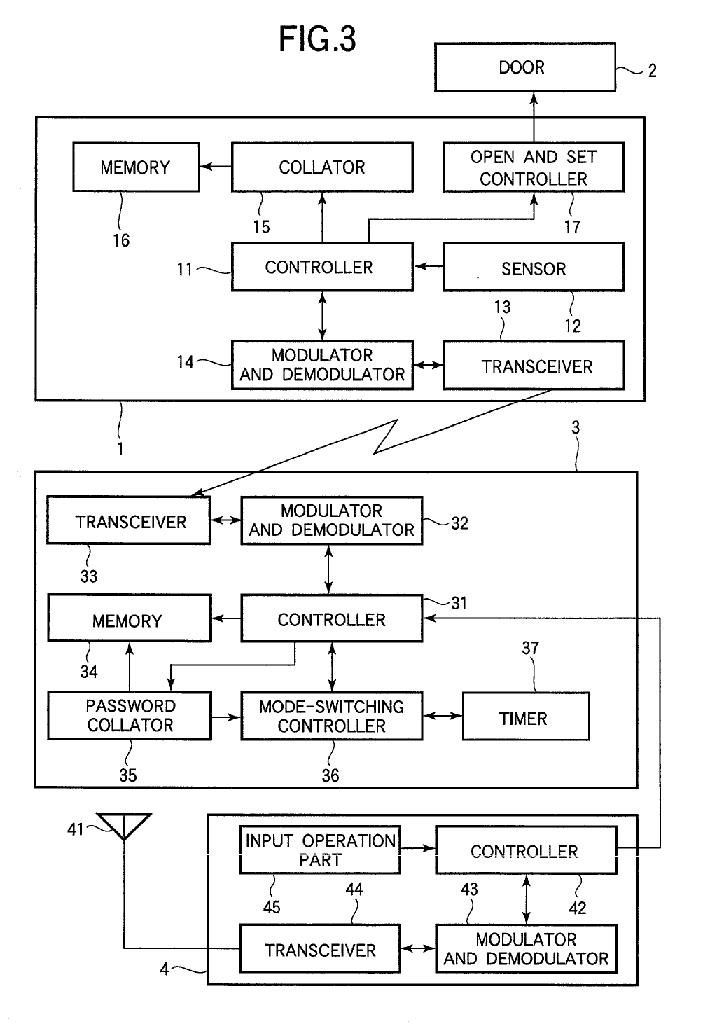

In the second embodiment, where an authenticated open and set function are activated after password is input into a portable terminal, such as a portable telephone and a personal digital assistance, will be described below. FIG. 3 is a block diagram showing a configuration of a lock with an authenticated open and set function according to the second embodiment of the present invention. In FIG. 3, like reference numerals in FIG. 1 indicate like elements, and the detailed descriptions thereof will be omitted.

In the configuration shown in FIG. 3, an IC card 3 comprises a password collator 35 for collating password input from a portable terminal, a mode-switching controller 36 for switching its mode to a mode for opening and setting after authentication when the password is collated, and, a timer 37 for measuring the time elapsed before the mode.

The IC card 3 is mounted in a portable terminal, for example, a portable telephone 4, and both are electrically connected to each other. The telephone 4 comprises an antenna 41 for transmitting and receiving radio signals, a controller 42 for controlling the whole device, a modulator and demodulator 43 for modulating transmission signals and for demodulating reception signals, a transceiver 44 for performing a given radio transmission processing (up-conversion, digital/analog conversion, and so on) of transmission signals, and a given radio reception (down-conversion, analog/digital conversion, and so on) of reception signals, and an input operation part 45 made of key buttons.

The operation of the lock having the above configuration will be described.

When a user holding the portable telephone 4 in which the IC card 3 is mounted approaches a door equipped with the lock, the user inputs password from the input operation part 45 of the portable telephone 4 in order to switch the IC card 3 to an authenticated open and set mode. The password is sent to the controller 42.

The controller 42 sends the password to the controller 31 of the IC card 3. Also, the controller 31 sends the password to the password collator 35. The collator 35 collates the password previously stored in the memory 34 with the password sent from the portable telephone 4. The collator 35 sends a collation signal to the mode-switching controller 36 when both of the passwords are coincided with each other. The mode-switching controller 36 switches from a normal mode to an authenticated open and set mode upon reception of the collation signal. At this time, the timer 37 starts time measurement.

Once the IC card 3 is switched to the authenticated open and set mode, an authenticated open and set operation is started in the same manner as the first embodiment.

When a user holding the portable telephone 4 mounted the IC card 3 approaches the door 2 equipped with the authenticated open and set function unit 1 to a predetermined distance, the sensor 12 of the authenticated open and set function unit 1 detects the access of the user, and then the detected signal is sent from the sensor 12 to the controller 11. The controller 11 modulates the control signal to a signal, which is good for transmission to the IC card 3, and sends it from the transceiver 13 to the IC card 3.

The IC card 3 sends the user identification information, that is, user IDs and log data stored in the memory 34 are sent to the authenticated open and set function unit 1. In the authenticated open and set function unit 1, the collator 15 collates the user identification information sent from the IC card 3 with that in the memory 16. When both of the user identification information are coincided with each other, the collator 15 sends the collation signal, which is indicative of the user being authenticated, to the controller 11.

On reception of the collation signal, the controller 11 gives the controller 17 a command to open the lock installed in the door 2. The controller 17 opens the lock based on the command from the controller 11. The controller 17 sets the lock when the door 2 is closed after it is opened once. Then, the oldest record in the log data are deleted, and new date and hour of the last opening is recorded to update the log data.

On the other hand, when the password is not collated, it aborts the authenticated open and set operation. Moreover, when a predetermined time has passed during the time measurement by the timer 37 before the operation is started, the mode-switching controller 36 of the IC card 3 is switched from the authenticated open and set mode to the normal mode. Thereby, it may be possible to switch its mode to a mode where the user identification information is transmitted only at the opening of the lock, and then to activate the function only when the lock is opened.

The lock according to the present embodiment is configured to collate the user identification information transmitted from the user side with that in the lock side, and to open the lock when both of the user identification information are coincided. Accordingly, a mere access of the IC card to the lock enables the opening of the lock, without any bothersome operation for inserting a key to open the lock.

The authenticated open and set operation is started after the collation of the password to check the identity of the user. This ensures prevention from being abused by other non-authorized person, even if the portable telephone 4 is lost.

In the second embodiment, the password is directly (over the wires) transmitted from the portable telephone 4 to the IC card 3. Nevertheless, it will be understood that the password may be transmitted from the transceiver 44 of the portable telephone 4 through the antenna 41, and received at the transceiver 33 of the IC card 3.

The present invention is not necessarily limited to the above first and second embodiments, and a number of modifications and variations may be made. For example, while the authenticated open and set function unit may be installed in a house in the above embodiments, the same effects can be obtained by installing it in a door of a car or a office, or in a bicycle. That is, installation of the authenticated open and set function units in those permits opening of various kinds of locks with only one IC card. In this case, either the same user identification information, or different user identification information may be allocated to each lock.

Additionally, whichever of a user identification information may be chosen. In this case, if the user ID is chosen, the only user ID will be collated, otherwise, the contents of the log data will be collated. If there is any user ID or log data coincided, the lock may be opened.

As mentioned above, according to the present invention, it may be possible to open a lock without any bothersome operation for inserting a key to open the lock, since the lock is configured to collate the user identification information transmitted from the user side with that in the lock side, and to open the lock when they are coincided each other.

1. A lock with an authenticated open and set function, said lock comprising:
a storage means for storing a first user identification information;
a collating means for collating a received second user identification information with said first user identification information stored in said storage means; and
a control means for opening a lock when said first and second user identification information are coincided with each other.

2. A lock according to claim 1, wherein said first and second user identification information comprise log data, respectively.

3. A lock according to claim 1, wherein said lock further comprises a detection means for detecting access of a transmission source of said second user identification information.

4. An IC card mounted in a portable terminal, said IC card comprising:
a storage means for storing said second user identification information; and
a transmission means for transmitting said second user identification information to the lock according to any one of claims 1 through 3.

5. An IC card according to claim 4, wherein said storage means stores a first password, and said IC card comprises a password collating means for collating said first password with a second password input from said portable terminal; and a mode-switching control means for switching its mode to a mode to transmit said first user identification information only when said first and second password are coincided with each other.

6. An IC card according to claim 5, wherein said mode-switching control means switches its mode to a mode where said second user identification information is transmitted for a predetermined time interval.
